(19) United States
(12) Patent Application Publication
(10) Pub. No.: US 2009/0117446 A1
(43) Pub. Date: May 7, 2009

(54) JOINT DEVICE FOR SENDING AND RECEIVING LIQUID AND FUEL CELL SYSTEM HAVING THE SAME

(75) Inventors: Toru Takahashi, Sagamihara-shi (JP); Nobuo Katsuura, Yokohama-shi (JP)

Correspondence Address: Studebaker & Brackett PC, 1890 Preston White Drive, Suite 105, Reston, VA, 20191, US

(73) Assignee: NIX, INC., Yokohama-shi, Kanagawa (JP)

(21) Appl. No.: 11/917,070

(22) PCT Filed: Mar. 17, 2006
(86) PCT No.: PCT/JP2006/305349

§ 371 Date: Dec. 10, 2007

(30) Foreign Application Priority Data
Jun. 10, 2005 (JP) 2005-171644

(51) Int. Cl. H01M 8/04

(52) U.S. Cl. 429/37; 429/34

(57) ABSTRACT

There are disclosed a joint device for sending and receiving a liquid and the like which have a structure preferable in securing alignment precision of connected portions during joining and maintaining fixing of these connected portions. In the joint device for sending and receiving the liquid, which connects a liquid reservoir to store the liquid to a liquid accepter to accept the liquid from the liquid reservoir, disengageable clasps (snap hooks) 3, 11 which align a liquid sending side joint 2 of the liquid reservoir with a liquid receiving side joint 5 of the liquid accepter and which maintain a state where the liquid reservoir is connected to the liquid accepter are disposed at the liquid sending side joint 2 of the liquid reservoir and the liquid receiving side joint 5 of the liquid accepter.

### BACKGROUND OF THE INVENTION

1. Technical Field

The present invention relates to a joint device for sending and receiving a liquid, and a fuel cell system including this device. More particularly, the present invention relates to a joint mechanism for introducing a liquid from a liquid reservoir to a liquid accepter in a device such as a fuel cell or an ink jet printer in which the liquid reservoir (a liquid supply container) as liquid supply means is separated from the liquid accepter (a liquid receiver).

2. Description of Related Art

At present, in an ink jet printer, a lighter using a liquid fuel, a medical device for administering a drug solution and the like, liquid supply means broadly spreads which includes a liquid reservoir to store a liquid and allow the liquid to flow out and a liquid accepter to accept the liquid from the liquid reservoir and to which the liquid reservoir is detachably attached. In the liquid supply means to which the liquid reservoir is detachably attached in this manner, when the supplied liquid runs short, the liquid reservoir itself can directly be replaced. Therefore, the means is excellent in that hands are scarcely made dirty by the liquid, high safety is achieved and the means can easily be replenished with the supplied liquid as compared with a case where the liquid is directly supplied to a reservoir tank or the like mounted in a main body of the device. It can be said that the liquid supply means is very effective especially in a case where the supplied liquid influences a human body or rapidly deteriorates when the liquid comes in contact with the outside air.

Moreover, in recent years, development of a fuel cell which generates power by use of the liquid as a fuel has been advanced. Especially, a direct methanol type fuel cell (DMFC) in which methanol is used as the fuel is more intensively developed by many electric appliance makers and the like, and is expected as a new cell of the next generation for use in a notebook-size personal computer, various portable electronic devices, a cellular phone and the like. However, methanol usually has a large influence on the human body, and methanol affects a central nerve, or causes dizziness or diarrhea when inhaled. Moreover, methanol is a highly risky and toxic liquid which generates a trouble in an optic nerve and which has a high risk that eyesight is lost in a case where a large amount of methanol is inhaled or enters eyes. Therefore, when the fuel is safely and easily supplied to a general consumer and the like even in the DMFC, means for supplying methanol by use of the liquid reservoir as a cartridge without directly handling methanol is supposed to be optimum, and broadly developed (Japanese Patent Application Laid-Open Nos. 2003-308871, 8-12301 and 2003-317756, etc.).

The above-mentioned liquid supply means needs to have a detachably attached joint for sending and receiving the liquid, which introduces the liquid from the liquid reservoir to the liquid accepter. Examples of a heretofore proposed joint include Japanese Patent Application Laid-Open Nos. 10-789 and 8-50042, Japanese Patent Publication No. 2003-528699, Japanese Patent Application Laid-Open No. 2003-266739, Japanese Patent Publication No. 2001-524896, and Japanese Patent Application Laid-Open Nos. 2000-289225, 7-68780, 5-254138 and 2003-331879.

Patent Document 1: Japanese Patent Application Laid-Open No. 10-789;

Patent Document 2: Japanese Patent Application Laid-Open No. 8-50042;

Patent Document 3: Japanese Patent Publication No. 2003-528699;

Patent Document 4; Japanese Patent Application Laid-Open No. 2003-266739;

Patent Document 5: Japanese Patent Publication No. 2001-524896;

Patent Document 6: Japanese Patent Application Laid-Open No. 2000-289225;

Patent Document 7: Japanese Patent Application Laid-Open No. 7-68780;

Patent Document 8: Japanese Patent Application Laid-Open No. 5-254138; and

Patent Document 9: Japanese Patent Application Laid-Open No. 2003-331879.

### SUMMARY OF THE INVENTION

However, a joint device for sending and receiving a liquid, which connects a liquid reservoir to a liquid accepter and which functions as a part of liquid supply means, has the following problem. That is, firstly, in a present situation, there has not been found the joint device having a structure preferable in securing aligning precision of connected portions (a liquid sending side joint (a liquid sending port) of the liquid reservoir and a liquid receiving side joint (a liquid receiving port) of the liquid accepter) during joining and maintaining fixing of these connected portions. Secondly, it is necessary to sufficiently consider securement of safety to infants, specifically prevention of leak of the liquid in the case of, for example, incorrect contact. Thirdly, it is important to securely prevent incorrect connection in a case where a type or a size of a container differs, for example, the liquid reservoirs have different contents or different sizes. However, there is not any mechanism configured to securely prevent the incorrect connection while solving the above-mentioned problem. Even if the mechanism exists, in a present situation, the number of components of such a mechanism is large, and a complicated mechanism is required. Therefore, there is a restriction on miniaturization and cost reduction of the existing joint device.

To solve the problem, an object is to provide a joint device for sending and receiving a liquid, which has a structure preferable in securing alignment precision of connected portions during joining and maintaining fixing of these connected portions, a joint device for sending and receiving a liquid, in which safety to infants is considered, and a joint device for sending and receiving a liquid, in which incorrect connection of a container having a different type or size can securely be prevented. Another object of the present invention is to provide a fuel cell system including such a joint device for sending and receiving the liquid.

As a result of intensive investigations of the present inventor on the above-mentioned problems of the conventional technology, a technology capable of solving such problems has been found. The present invention is based on such finding, and characterized by a joint device for sending and receiving a liquid, which connects a liquid reservoir to store the liquid to a liquid accepter to accept the liquid from the liquid reservoir, wherein disengageable clasps which align a liquid sending side joint of the liquid reservoir with a liquid receiving side joint of the liquid accepter and which maintain a state where the liquid reservoir is connected to the liquid accepter are disposed at the liquid sending side joint of the liquid reservoir and the liquid receiving side joint of the liquid accepter.

According to such a joint device for sending and receiving the liquid, the liquid sending side joint of the liquid reservoir and the liquid receiving side joint of the liquid accepter can be aligned using the clasps In addition, these clasps are disengageably engaged. Therefore, in a case where the clasp of the liquid sending side joint and the clasp of the liquid receiving side joint are aligned and clasped together, a state in which the liquid reservoir is connected to the liquid accepter can easily be maintained.

Moreover, the present invention is characterized by a joint device for sending and receiving a liquid, which connects a liquid reservoir to store the liquid to a liquid accepter to accept the liquid from the liquid reservoir, wherein a safety mechanism which prevents liquid leak from a supply valve due to incorrect contact at a time other than a joining time is disposed at a liquid sending side joint of the liquid reservoir.

According to this joint device for sending and receiving the liquid, owing to a function of the safety mechanism disposed at the liquid sending side joint of the liquid reservoir, the liquid leak from the supply valve due to the incorrect contact at the time other than the joining time can be prevented. In consequence, even if, for example, an infant touches or holds the liquid accepter, sufficient safety can be secured.

Furthermore, the present invention is characterized by a joint device for sending and receiving a liquid, which connects a liquid reservoir to store the liquid to a liquid accepter to accept the liquid from the liquid reservoir, wherein mechanical key mechanisms which prevent a liquid reservoir having a different standard, size and the like from being joined are disposed at joints of the liquid reservoir and the liquid accepter, respectively.

According to such a joint device for sending and receiving the liquid, owing to the function of the mechanical key mechanisms disposed at the joints (a liquid sending side joint of the liquid reservoir, a liquid receiving side joint of the liquid accepter) of the liquid reservoir and the liquid accepter, the liquid reservoir having the different standard, size and the like can securely be prevented from being joined.

Moreover, it is preferable that the safety mechanism which prevents the liquid leak in the joint device for sending and receiving the liquid is a guard for the prevention of the liquid leak disposed at the joint of the liquid reservoir, and is formed so as to satisfy the following relation:

(d/S)≧4×10⁻³, in which S is a hole area of a through hole to pass the liquid, disposed at a front surface of the guard, and d is a length from the front surface of the guard to the supply valve.

According to this joint device for sending and receiving the liquid, since the through hole for passing the liquid having a sufficient depth for the hole area, is formed. Therefore, even if infants touch the liquid sending side joint of the liquid reservoir by mistake, it can securely be prevented that the supply valve is touched by mistake.

Furthermore, the invention according to claim 5 is characterized by the joint device for sending and receiving the liquid according to claim 1, which comprises the safety mechanism according to claim 2 or 4. According to this joint device for sending and receiving the liquid, since the device includes the clasps of claim 1 and the safety mechanism of claim 2 or 4, the device can have effects of both the inventions. That is, the liquid sending side joint of the liquid reservoir and the liquid receiving side joint of the liquid accepter are aligned using the clasps, and simultaneously with this alignment, the state in which the liquid reservoir is connected to the liquid accepter can be maintained. The safety mechanism can prevent the liquid leak from the supply valve due to the incorrect contact at the time other than the joining time, and can be formed so as to satisfy the following:

(d/S)≧4×10⁻³, in which S is the hole area of the through hole and d is the length from the front surface of the guard to the supply valve, so that the liquid leak can more securely be prevented.

Furthermore, the joint device for sending and receiving the liquid according to the present invention is characterized in that mechanical key mechanisms which prevent a liquid reservoir having a different standard, size and the like from being joined are disposed at a liquid sending side joint of the liquid reservoir and a liquid receiving joint of the liquid accepter, respectively.

According to such a joint device for sending and receiving the liquid, the liquid sending side joint of the liquid reservoir and the liquid receiving side joint of the liquid accepter can be aligned using the clasps, simultaneously with this alignment, the state in which the liquid reservoir is connected to the liquid accepter can be maintained, and additionally owing to the function of the mechanical key mechanism, for example, the liquid reservoir having the different standard, size and the like can securely be prevented from being joined. When the safety mechanism is further disposed, the liquid leak from the supply valve due to the incorrect contact at the time other than the joining time can be prevented, and the mechanism is formed so as to satisfy the following in the same manner as described above:

(d/S)≧4×10⁻³, whereby the liquid leak can more securely be prevented. That is, in this case, the joint device for sending and receiving the liquid can be a so-called multifunctional joint device which can solve any of three problems of the conventional technology described above.

Moreover, in this case, it is preferable that the mechanical key mechanisms are constituted of concave portions disposed at a male side member and a female side member constituting the clasps and convex portions formed into such a shape as to be fitted into the concave portions.

According to this joint device for sending and receiving the liquid, the mechanical key mechanisms have a structure in which the convex portions disposed at the male-side member (or the female-side member) are fitted into the concave portions disposed at the female-side member (or the male0side member), whereby the liquid reservoir having the different standard, size and the like can further securely be prevented from being joined.

Furthermore, the present invention is a fuel cell system including the above-mentioned joint device for sending and receiving the liquid, and the liquid reservoir is applied to a fuel cell using a liquid fuel.

According to this fuel cell system, there can be obtained a system including the joint device having at least one of a function of aligning the liquid sending side joint of the liquid reservoir and the liquid receiving side joint of the liquid accepter by use of the clasps and maintaining the state in which the liquid reservoir is connected to the liquid accepter simultaneously with this alignment, a function of the mechanical key mechanism capable of securely preventing, for example, the liquid reservoir having the different standard, size and the like from being joined and a function of the safety mechanism capable of preventing the liquid leak from the supply valve due to the incorrect contact at the time other than the joining time.

In this case, in the fuel cell system, a fuel containing at leas methanol may be used as the liquid fuel. According to such a fuel cell system, the fuel cell system in which the methanol containing fuel is used can include the joint device having a function similar to the above-mentioned function.

According to the present invention, there can be provided a joint device for sending and receiving a liquid, which has a structure preferable in securing alignment precision of connected portions during joining and maintaining fixing of these connected portions, a joint device for sending and receiving a liquid, in which safety to infants is considered, a joint device for sending and receiving a liquid, in which incorrect connection of a container having a different type or size can securely be prevented, and a fuel cell system including such a joint device for sending and receiving the liquid.

### BRIEF DESCRIPTION OF THE DRAWINGS

FIG. 1 is a perspective view showing a liquid reservoir of a joint device for sending and receiving a liquid;

FIG. 2 is a perspective view showing a liquid accepter of the joint device for sending and receiving the liquid;

FIG. 3 is a perspective view showing the liquid reservoir and the liquid accepter when joined;

FIG. 4 is a side view partially showing a configuration of the joint device for sending and receiving the liquid which includes the joined liquid reservoir and liquid accepter;

FIG. 5 is a sectional view cut along the V-V line of FIG. 4;

FIG. 6 is a front view showing one example of a liquid receiving side joint disposed at the liquid accepter;

FIG. 7 is a sectional view of the liquid receiving side joint shown in FIG. 6;

FIG. 8 is a sectional view cut along the VIII-VIII line of FIG. 7;

FIG. 9 is a side view showing one example of a liquid sending side joint disposed at the liquid reservoir;

FIG. 10 is a front view of the liquid sending side joint shown in FIG. 9;

FIG. 11 is a sectional view cut along the XI-XI line of FIG. 10;

FIG. 12 is a sectional view cut along the XII-XII line of FIG. 10;

FIG. 13 is a front view showing one example of the liquid sending side joint in a case where another mechanical key mechanism is disposed;

FIG. 14 is a sectional view cut along the XIV-XIV line of FIG. 13;

FIG. 15 is a front view showing one example of the liquid sending side joint in a case where another mechanical key mechanism is disposed;

FIG. 16 is a sectional view cut along the XVI-XVI line of FIG. 15;

FIG. 17 is a sectional view showing another example of the joint device for sending and receiving the liquid during joining;

FIG. 18 is a front view showing one example of the liquid sending side joint in a case where a shape of the other mechanical key mechanism is further changed;

FIG. 19 is a front view showing one example of the liquid receiving side joint in a case where the shape of the other mechanical key mechanism is further changed;

FIG. 20 is a graph showing a relation of a safety mechanism between a hole diameter φ and a depth (or a thickness) d;

FIG. 21 is a schematic diagram showing one example of a fuel cartridge and a fuel cell including the joint device for sending and receiving the liquid;

FIG. 22 is a schematic diagram showing a connected state of the joint device for sending and receiving the liquid shown in FIG. 21; and

FIG. 23 is a schematic diagram showing one embodiment of a fuel cell system according to the present invention.

### DETAILED DESCRIPTION OF PREFERRED EMBODIMENT

A constitution of the present invention wilt hereinafter be described based on one example of an embodiment shown in the drawings.

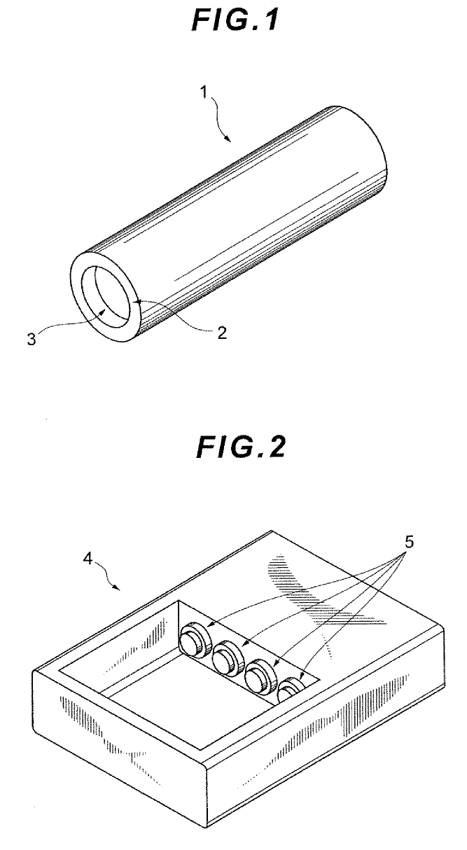

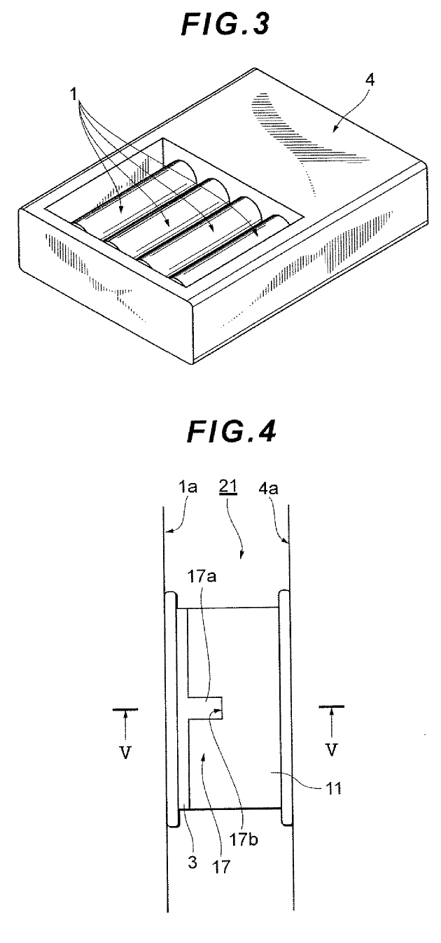

FIGS. 1 to 12 show one embodiment of the present invention. A liquid reservoir 1 of the present embodiment is, for example, a methanol fuel cartridge for use in a DMFC, and 3 wt % of a methanol aqueous solution is introduced beforehand in the cartridge as one example (see FIG. 1). A DMFC main body is incorporated in a liquid accepter 4. To supply the liquid in the liquid reservoir 1 to the liquid accepter 4, the liquid reservoir is used in a state in which a liquid sending side joint 2 is connected to a liquid receiving joint 5 (see FIG. 3). When the liquid is sent from the liquid reservoir 1 to the liquid accepter 4 in this manner, in order to connect the liquid reservoir 1 in which the liquid is stored to the liquid accepter 4 which receives the liquid from the liquid reservoir 1, a joint device 21 for sending and receiving the liquid according to the present invention is constituted of the joints 2, 5 (see FIG. 4, etc.).

Here, the joint device 21 for sending and receiving the liquid in the present embodiment includes disengageable clasps 3, 11 for connecting the liquid sending side joint 2 of a liquid sending port of the liquid reservoir 1 to the liquid receiving side joint 5 of a liquid receiving port of the liquid accepter 4 (see FIGS. 1, 2 and 4). These clasps 3, 11 are disengageable members which are disposed at the liquid sending side joint 2 of the liquid reservoir 1 and the liquid receiving side joint 5 of the liquid accepter 4 so as to align the liquid sending side joint 2 of the liquid reservoir 1 with the liquid receiving side joint 5 of the liquid accepter 4 and which maintain a state where the liquid reservoir 1 is connected to the liquid accepter 4. There is not any special restriction on specific examples of such clasps 3, 11, but members which can comparatively easily be clasped and detached and which are inexpensive and lightweight are preferable. As one example, a member is applicable in which a hook-like portion referred to as a snap or a hook and a receiving portion form one set (hereinafter referred to also as “the snap hook” in the present embodiment). From a viewpoint that the members are inexpensive and lightweight, it is preferable to employ the flexible plastic clasps 3, 11 made of plastic. For example, in the present embodiment, the round snap hooks 3, 11 including both convex and concave members are employed (see FIGS. 4 to 12).

First, a constitution on the side of the liquid accepter 4 will be described (see FIGS. 6 to 8). In a main body side housing 4a of the liquid accepter 4, a portion to be connected to the liquid reservoir 1 (a front surface of the liquid accepter 4) is provided with the liquid receiving side joint 5 (see FIG. 8, etc.). This liquid receiving side joint 5 has a nozzle shape which protrudes toward the liquid reservoir 1, and a circulation path 6 for circulating the liquid is disposed at the center of this nozzle (denoted with reference numeral 7) portion.

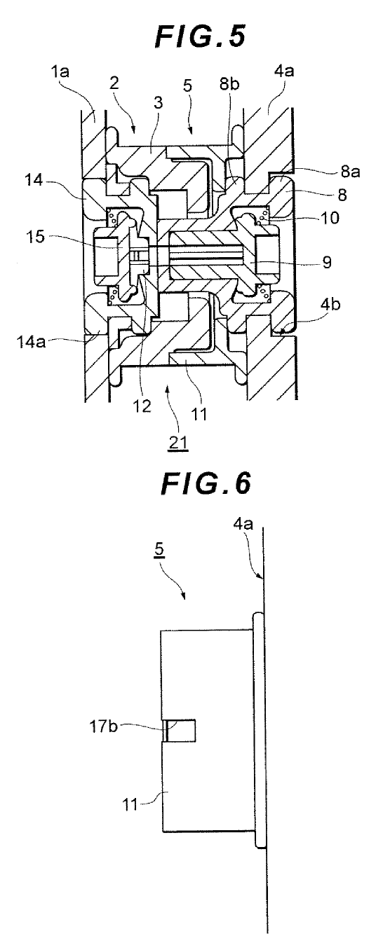

Moreover, in the present embodiment, the front surface of the main body side housing 4a is provided with a through hole 4b, and the above-mentioned nozzle 7 is supported by a rubber packing 8 attached to this through hole 4b. For example, the rubber packing 8 of the present embodiment has a substantially tapered shape having a circular section so that the nozzle 7 can be stored in a baggy portion disposed at a tip end portion of the packing. A root portion of the rubber packing 8 is provided with two rows of flanges 8a, 8b. Once the packing is attached to the through hole 4b of the main body side housing 4a, the packing is not easily detached (see FIG. 8). Furthermore, needless to say, this rubber packing 8 has elasticity. When the liquid sending side joint 2 is pressed onto the packing during joining, the packing can be deformed toward the main body side housing 4a (see FIG. 5). Therefore, the above-mentioned nozzle 7 as a circulation hole of the liquid can move in a central axis direction of the main body side housing 4a (i.e., a direction in which the liquid is circulated) as much as an amount substantially equal to a deformation amount of this rubber packing 8.

Moreover, in a space formed between the nozzle 7 and the main body side housing 4a on an inner side of the rubber packing 8, a valve 9 and a spring member 10 are disposed so as to be movable in the central axis direction (i.e., the direction in which the liquid is circulated) of the main body side housing 4a (see FIG. 8, etc.). Since this valve 9 is usually pressed toward the nozzle 7 by the spring member 10, the circulation path 6 is closed so that the liquid is not circulated (see FIG. 8). However, during the joining, the liquid sending side joint 2 is pressed onto the packing, whereby the packing moves back toward the main body side housing 4a and opens the circulation path 6 to obtain a state in which the liquid can be circulated (see FIG. 5). The spring member 10 is constituted of a spiral spring or the like coated with, for example, Teflon (registered trademark) (see FIG. 8, etc.).

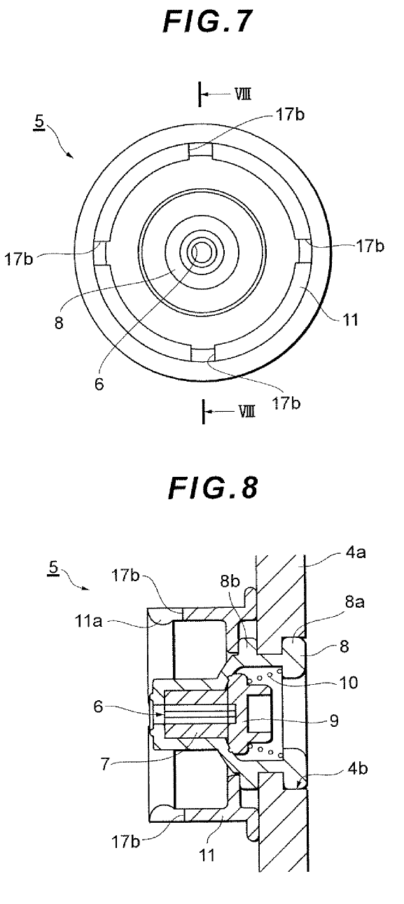

Furthermore, in the present embodiment, the joint device 21 for sending and receiving the liquid which connects the liquid reservoir 1 to this liquid accepter 4 includes the liquid sending side joint 2 and the joint 5 for receiving the liquid. For example, in the present embodiment, it is assumed that the joint 5 for receiving the liquid disposed on the liquid accepter 4 includes the female cylindrical snap hook (clasp) 11 into which the liquid sending side joint 2 on the liquid reservoir 1 side is fitted (see FIGS. 7, 8). In this case, the cylindrical snap hook 11 is concentrically arranged so that the center of the hook agrees with that of the joint 5 for the receiving the liquid. As described later, the snap hook 3 disposed on the liquid reservoir 1 is similarly concentrically arranged so that the center of the hook agrees with that of the liquid sending side joint 2 (see FIG. 10, etc.). Therefore, according to the joint device 21 for sending and receiving the liquid of the present embodiment, the liquid reservoir 1 is joined to the liquid accepter 4, and further the liquid sending side joint 2 of the liquid reservoir 1 can be so-called automatically aligned with the liquid receiving side joint 5 of the liquid accepter 4. It is to be noted that the snap hook 11 is attached to the main body side housing 4a by use of, for example, an adhesive or another clasp. In this case, as a specific example of the clasp, a push nut, a screw or the like is considered. Alternatively, it is considered that the snap hook 11 be attached by welding.

In addition, the above-mentioned snap hook 11 is disengageably engaged so that a joined state (a state in which the liquid reservoir 1 is connected to the liquid accepter 4) can be maintained and that the hook can be detached. In this case, there is not any special restriction on a specific constitution for disengageably engaging the hook. For example, in the present embodiment, the snap hook 11 on the liquid receiving side is provided with a convex engagement portion 11a beforehand, and it is constituted that the engagement portion is disengageably engaged with the snap hook 3 on the liquid sending side and that the portion is not naturally easily detached. More specifically, peripherally continuous undulations are disposed close to a tip end of the cylindrical liquid receiving side snap hook 11 on an inner peripheral surface of the hook, so that the undulations are hooked on an outer peripheral surface of the liquid sending side snap hook 3 (see FIG. 8, etc.).

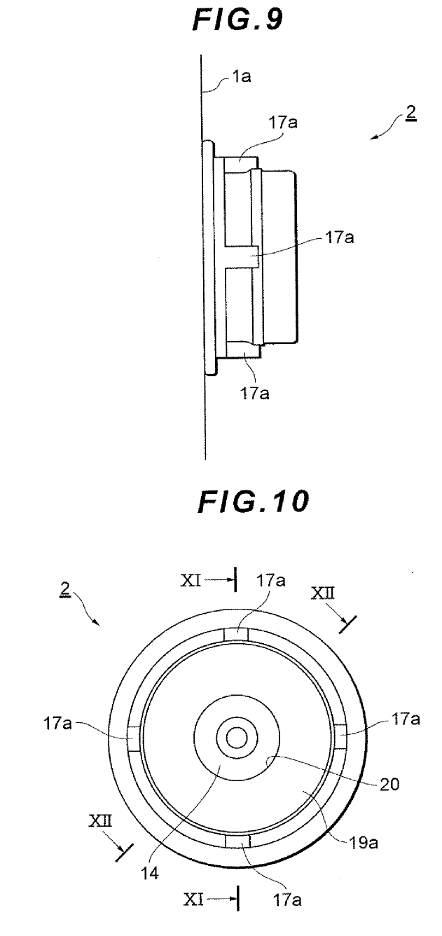

The constitution on the side of the liquid accepter 4 has been described above, and next a constitution on the side of the liquid reservoir 1 will be described (see FIGS. 9 to 12). A portion of a main body side housing 1a of the liquid reservoir 1 to be connected to the liquid accepter 4 (a front surface of the liquid reservoir 1) is provided with the liquid sending side joint 2 (see FIG. 9, etc.). This liquid sending side joint 2 has a nozzle shape which protrudes toward the liquid accepter 4, and the center of this nozzle (denoted with reference numeral 12) portion is provided with a circulation path 13 for circulating the liquid.

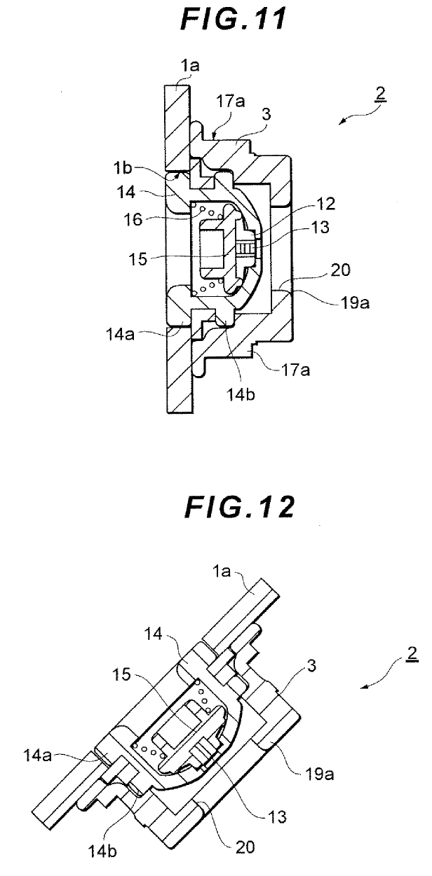

Moreover, in the present embodiment, a front surface of the main body side housing 1a is provided with a through hole 1b, and the above-mentioned nozzle 12 is supported by a rubber packing 14 attached to this through hole 1b. For example, the rubber packing 14 of the present embodiment has a circular section, and a tip end portion of the packing has a substantially domed shape so that the nozzle 12 can be stored on an inner side of the domed portion (see FIG. 11). A root portion of the rubber packing 14 is provided with two rows of flanges 14a, 14b. Once the packing is attached to the through hole 1b of the main body side housing 1a, the packing is not easily detached (see FIG. 11). Needless to say, this rubber packing 14 has elasticity. When the liquid sending side joint 5 is pressed onto the packing during the joining, the packing can be deformed toward the main body side housing 1a (see FIG. 5). Therefore, the above-mentioned nozzle 12 as an outflow hole of the liquid can move in a central axis direction of the main body side housing 1a (i.e., a direction in which the liquid is circulated) as much as an amount substantially equal to a deformation amount of this rubber packing 14.

Moreover, in a space formed between the nozzle 12 and the main body side housing 1a on the inner side of the rubber packing 14, a valve 15 and a spring member 16 are disposed so as to be movable in the central axis direction (i.e., the direction in which the liquid is circulated) of the main body side housing 1a (see FIG. 11, etc.). Since this valve 15 is usually pressed toward the nozzle 12 by the spring member 16, the circulation path 13 is closed so that the liquid is not circulated (see FIG. 11). However, during the joining, the liquid receiving side joint 5 is pressed onto the packing, whereby the packing moves back toward the main body side housing 1a and opens the circulation path 13 to obtain a state in which the liquid can be circulated (see FIG. 5). The spring member 16 is constituted of a spiral spring or the like coated with, for example, Teflon (registered trademark) (see FIG. 11, etc.).

Furthermore, in the present embodiment, the joint device 21 for sending and receiving the liquid which connects this liquid reservoir 1 to the liquid accepter 4 includes the liquid sending side joint 2 and the joint 5 for receiving the liquid as described above. Here, for example, in the present embodiment, it is assumed that the liquid sending side joint 2 disposed on the liquid reservoir 1 is constituted of the male cylindrical snap hook (clasp) 3 to be fitted into the joint 5 for receiving the liquid on the liquid accepter 4 side (see FIGS. 11, 12, etc.). In this case, the cylindrical snap hook 3 is concentrically arranged so that the center of the hook agrees with that of the liquid sending side joint 2. In consequence, according to the joint device 21 for sending and receiving the liquid of the present embodiment, the liquid reservoir 1 is joined to the liquid accepter 4, and further the liquid sending side joint 2 of the liquid reservoir 1 can be so-called automatically aligned with the liquid receiving side joint 5 of the liquid accepter 4.

In addition, the above-mentioned snap hook 3 is disengageably engaged so that a joined state (a state in which the liquid reservoir 1 is connected to the liquid accepter 4) can be maintained, and the hook can be detached. In this case, there is not any special restriction on a specific constitution for disengageably engaging the hook. For example, in the present embodiment, the snap hook 11 on the liquid receiving side is provided with the convex engagement portion 11a beforehand, and it is constituted that this engagement portion 11a is disengageably engaged with the snap hook 3 on the liquid sending side and that the portion is not naturally easily detached (see FIG. 1, etc.).

It is to be noted that the above-mentioned valves 9, 15 will further be described. These valves 9, 15 are formed into shapes and sizes so that a liquid channel can be formed between each valve and the rubber packing 8 (or 14) at a time when the valve moves back toward the main body side housing 1a (or 4a). As a material of such valves 9, 15, metal, plastic, wood, ceramic or the like is usable, but it is preferable to employ the metal or the plastic among these materials in consideration of durability, function and the like. It is to be noted that specific examples of the metal include stainless steel, aluminum, iron, copper, silver, platinum and gold. Examples of the plastic include polyethylene, polypropylene, vinyl chloride resin, polystyrene. ABS resin, methacrylate resin, polyethylene terephthalate, polyamide, polycarbonate, polyacetal, polybutylene terephthalate, modified polyphenylene ether, polyphenylene sulfide, liquid crystal polymer, polysulfone, polyether sulfone, polyarylate, polyether ether ketone, polyphthal amide, polyimide, polyether imide, polyamide imide, polymethyl pentene, fluorine resin, polyvinylidene fluoride, TEFE, PFA, phenol resin, urea resin, melamine resin, unsaturated polyester, diallyl phthalate resin, epoxy resin, polyurethane resin and silicone resin.

The joint device 21 for sending and receiving the liquid has been described above. According to such a joint device 21 for sending and receiving the liquid, the liquid sending side joint 2 of the liquid reservoir 1 and the liquid receiving side joint 5 of the liquid accepter 4 can be aligned using the snap hooks (the clasps) 3, 11. In addition, the clasps 3, 11 are disengageably attached. Therefore, when the snap hook 3 of the liquid sending side joint 2 and the snap hook 11 of the liquid receiving side joint 5 are aligned and clasped together, a state in which the liquid reservoir 1 is connected to the liquid accepter 4 can easily be maintained.

It is to be noted that in the above-mentioned joint device 21 for sending and receiving the liquid, it is preferable that mechanical key mechanisms are disposed at the joints 2, 5 of the liquid reservoir 1 and the liquid accepter 4, respectively. That is, it is effective to dispose such a mechanical key mechanism beforehand, because the liquid reservoirs 1 having different standards, sizes and the like can effectively be prevented from being joined. One configuration in a case where such a mechanical key mechanism is disposed will hereinafter be described (see FIG. 4, etc., the mechanical key mechanism will hereinafter be denoted with reference numeral 17).

The mechanical key mechanism can be formed of, for example, a male-side member (the snap hook 3 in the above-mentioned embodiment) and a female-side member (the snap hook 11 in the above-mentioned embodiment) constituting the snap hooks. For example, in the present embodiment, four convex portions 17a are disposed every 90 degrees at an outer peripheral surface of the snap hook 3 of the liquid reservoir 1 (see FIGS. 9, 10, etc.), and four concave portions 17b constituted of cutouts having such size and shape that these convex portions 17a are fitted into the concave portions are disposed every 90 degrees at the snap hook 11 of the liquid accepter 4 (see FIG. 7, etc.). Such convex portions 17a and concave portions 17b merely constitute one example of the mechanical key mechanism 17. However, when a structure of the mechanical key mechanism 17 is changed with differences in a case where, for example, liquid reservoir 1 and the liquid accepter 4 to be joined to each other have different standards, sizes, types, specifications and the like, so that incorrect joining in a case where the standard, the size and the like differ can effectively be prevented. As a specific example in which the structure of the mechanical key mechanism 17 is changed, the shape, the size, the number and the like of the convex portions 17a and the concave portions 17b are appropriately changed. Needless to say, the liquid accepter 4 may be provided with the convex portions 17a and the liquid reservoir 1 may be provided with the concave portions 17b to constitute a configuration reverse to the above embodiment. In addition, when the concave portions 17b of the mechanical key mechanism 17 are constituted of, for example, four cutouts as described above (see FIG. 7, etc.), flexibility of the cylindrical female snap hook 11 increases to easily deflect the hook externally. Therefore, for example, in a case where a diameter of this female snap hook 11 is set to be slightly small beforehand and a comparatively tightly fitted state (a so-called clasping fit state) is achieved, it can be prevented that the mechanism is easily detached so that the joined state is maintained while the joining is facilitated.

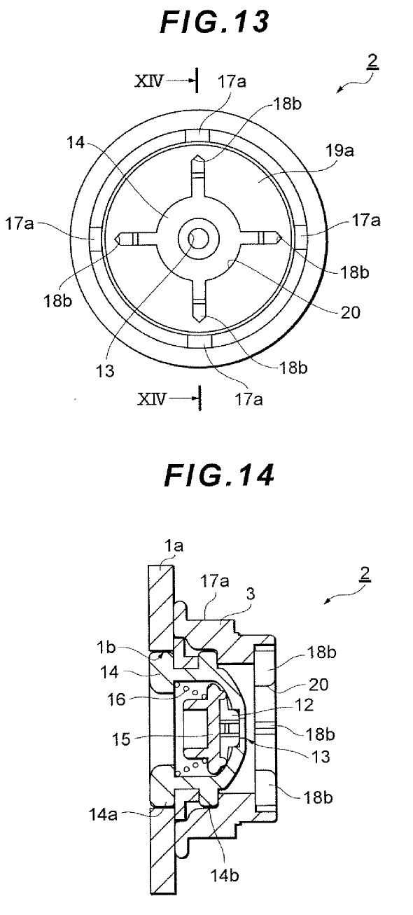

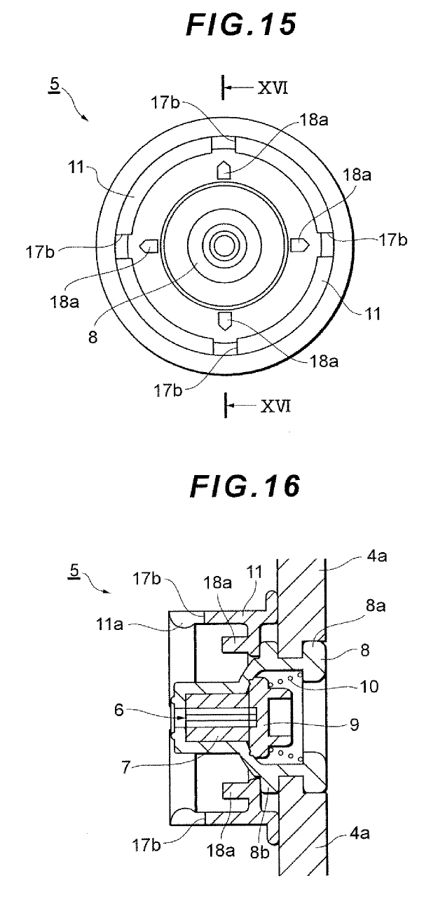

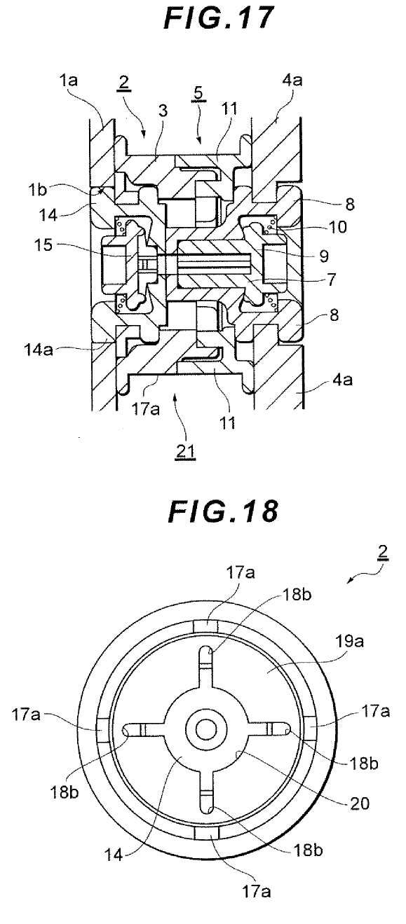

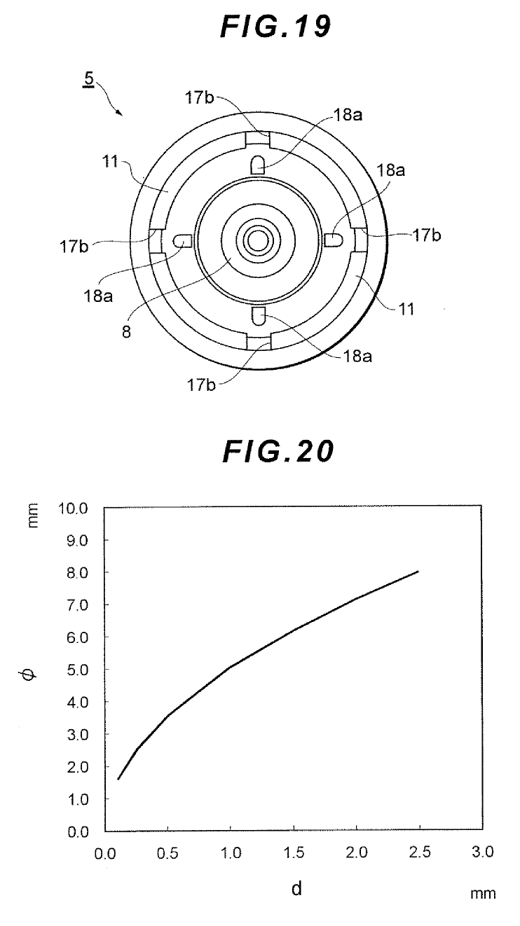

Alternatively, a function of the mechanical key mechanism may be strengthened by forming convex and concave portions separately from the above-mentioned portions. Such an example will hereinafter be described (see FIGS. 13 to 17). In the joint device 21 for sending and receiving the liquid shown in, for example, FIG. 13 and the like, in addition to the above-mentioned mechanical key mechanism 17, another mechanical key mechanism 18 is disposed. This mechanical key mechanism 18 is constituted of concave portions 18b formed at the snap hook 3 of the liquid reservoir 1 and the convex portions 18a formed at the snap hook 11 of the liquid accepter 4. More specifically, the snap hook 3 is provided with four cutouts extending radially around the through hole for passing the liquid (see FIG. 13). Outward end portions of these cutouts constituting the concave portions 18b are formed into a substantially triangularly pointed shape. On the other hand, the snap hook 11 of the liquid accepter 4 is provided with four convex portions 18a formed into such a shape as to be just fitted into these concave portions 18b (see FIGS. 15, 16). More specifically, the convex portions are formed into such a shape to be just fitted into tip end portions of the concave portions 18b, and four convex portions 18a having a substantially pentagonal shape protruding toward the liquid reservoir 1 are disposed at an equal interval along the same circle around the through hole for passing the liquid. In a case where such a liquid reservoir 1 is joined to the liquid accepter 4, not only the above-mentioned mechanical key mechanism 17 but also the mechanical key mechanism 18 function as keys, so that the liquid reservoir 1 and the liquid accepter 4 having different standards, sizes, types, specifications and the like can further effectively be prevented from being incorrectly joined to each other.

Moreover, assuming that the mechanical key mechanism 18 having such a separate structure is added, there is an advantage that the key can further easily be changed. One example of the mechanism will be described. The outward end portions of the concave portions 18b which have been substantially triangularly pointed in FIG. 13 and the like are formed into a semicircular shape (see FIG. 18), and four convex portions 18a which have been formed into the substantially pentagonal shape are formed into a shape in which a semicircular shape is combined with a quadrangular shape (so-called a circular shape with a rectangular frontage). In a case where the mechanical key mechanism 18 having the separate structure is added in this manner, shapes of details can slightly be changed to constitute the different key, which is therefore especially effective in a case where various specifications, sizes and the like are to be handled.

It is to be noted that the above-mentioned embodiment is one preferable example of the present invention, but the present invention is not limited to this embodiment, and can variously be modified without departing from the scope of the present invention. For example, in the present embodiment, a case where the disengageable snap hooks 3, 11 are disposed and the mechanical key mechanisms 17, 18 are further disposed has been described, but as the case may be, it is preferable that a safety mechanism to prevent liquid leak from a supply valve (the valve 15 disposed in the liquid reservoir 1 in this case) due to incorrect contact at a time other than the joining time is disposed on the liquid sending side joint 2 of the liquid reservoir 1. The joint device 21 for sending and receiving the liquid, provided with such a safety mechanism, will hereinafter be described (see FIG. 11, etc.).

For example, in the joint device 21 for sending and receiving the liquid, as shown in FIG. 11 and the like, the safety mechanism (denoted with reference numeral 19) for preventing the liquid leak is constituted of a guard 19a for preventing the liquid leak which is disposed at the liquid sending side joint 2 of the liquid reservoir 1. More specifically, a front surface (a surface which faces the liquid accepter 4) of the snap hook 3 is formed into an inwardly bent shape to cover the supply valve 15, and a through hole 20 for passing the liquid is disposed at the center of the surface (see FIG. 11, etc.). In this case, for example, if an infant or the like touches or carries the liquid reservoir 1 by mistake and presses the finger onto the liquid sending side joint 2, contact with the supply valve 15 is prevented to avoid unexpected liquid leak, and sufficient safety can be secured. In this case, as the safety mechanism 19, it is preferable that a depth (or a thickness) from the guard 19a to the supply valve 15 is sufficient for a hole area of the through hole 20 for passing the liquid. When the sufficient depth is secured, occurrence of the unexpected liquid leak can more securely be avoided. In this case, the sufficient depth varies with the shape and the size of the liquid reservoir 1, a shape, a size and the like of the liquid sending side joint 2 concerned with the reservoir and the like, but the following is generally preferable.

That is, it is preferable that the safety mechanism is formed so as to satisfy the following relation:

(d/S)≧4×10⁻³, in which S is a hole area of the through hole 20 for passing the liquid, disposed at the front surface of the guard 19a, and d is a length from the front surface of the guard 19a to the supply valve 15. This is a relation formula obtained as a result of consideration of various values of a diameter φ of the through hole 20 and sufficient depths d for the values (see Table 1), and it is considered based on this formula that in a range approximately below a line of a graph in FIG. 20 showing a relation between the hole diameter φ and the depth (or the thickness) d, the safety can be secured by setting the depth d to be sufficient.

TABLE 1

| d | S | φ |
|---|---|---|
| 0.1 | 25.0 | 1.6 |
| 0.3 | 62.5 | 2.5 |
| 0.5 | 125.0 | 3.6 |
| 1.0 | 250.0 | 5.0 |
| 1.5 | 375.0 | 6.2 |
| 2.0 | 500.0 | 7.1 |
| 2.5 | 625.0 | 8.0 |

However, the above-mentioned example is merely a preferable example in a case where the through hole 20 is formed into a circular shape, and this cannot necessarily apply if the through hole 20 has a shape other than the circular shape. In short, it is demanded that the safe depth d is appropriately secured in accordance with the shape, the size and the like of the through hole 20.

As described above, various actual applications of the joint device 21 for sending and receiving the liquid can be considered, but considering from the above-mentioned high safety and function, the present invention is especially preferable in a fuel cell system 22 or the like in which the liquid reservoir 1 is applied to a fuel cell using a liquid fuel. When a fuel containing at least methanol as the liquid fuel of such a fuel cell system 22 is used, it can be said that the above-mentioned joint device 21 for sending and receiving the liquid is remarkably preferable even in securing higher safety.

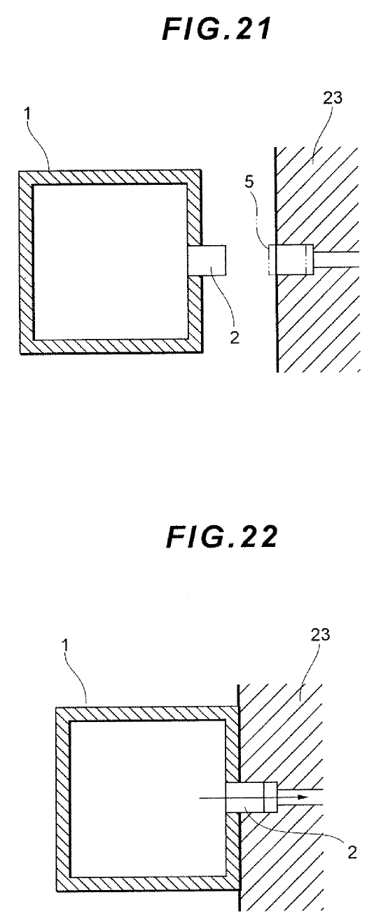

Here, an embodiment of the fuel cell system 22 including the above-mentioned joint device 21 for sending and receiving the liquid will be described with reference to the drawings (see FIGS. 21 to 23). For example, in the present embodiment, a fuel cartridge case in which a methanol fuel is incorporated corresponds to the liquid reservoir 1. A liquid sending port of the fuel cartridge case is provided with the liquid sending side joint 2 (see FIG. 21). A liquid receiving port of a fuel cell 23 constituting the fuel cell system 22 is provided with the liquid receiving side joint 5 (see FIG. 21). The above-mentioned liquid sending side joint 2 is connected to the liquid receiving side joint 5, whereby the fuel (methanol) in the fuel cartridge case can be supplied to the fuel cell 23 without spilling any fuel (see FIG. 22).

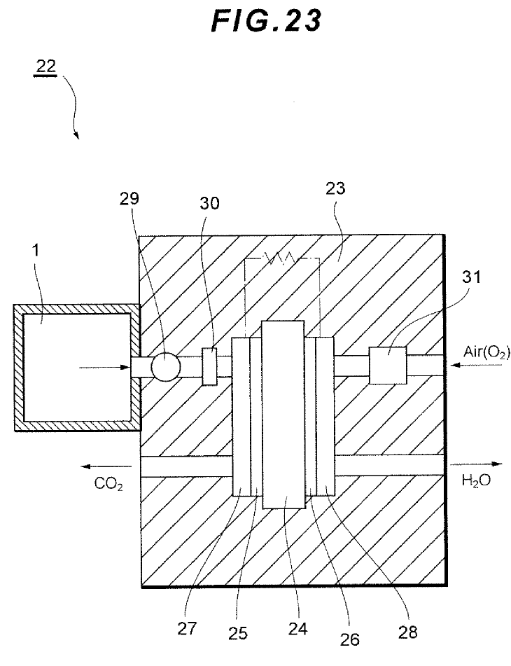

Moreover, here, a constitution of the fuel cell system 22 will schematically be described (see FIG. 23). The fuel cell (DMFC) 23 of a direct methanol type in the present embodiment includes an electrolytic film 24 made of, for example, perfluorosulfonic acid based polymer or the like, an anode electrode 25 disposed on one surface of this electrolytic film 24, a cathode electrode 26 disposed on the other surface and a pair of separators 27, 28 arranged so as to nip both of the electrodes 25, 26 therebetween. For example, in the present embodiment, the fuel (methanol) supplied from a fuel cartridge is passed through a pump 29 and a filter 30, and supplied toward the anode electrode 25 (see FIG. 23). On the other hand, atmospheric air is blown into the side of the cathode electrode 26 to supply oxygen to the electrode side. In this case, it is preferable to dispose an air blowing mechanism 31 constituted of, for example, a fan or the like halfway along a path for blowing the air. In consequence, a supply amount of oxygen can be increased if necessary (see FIG. 23). Methanol and oxygen supplied as described above generate power owing to chemical reaction, and are discharged as water or CO2 from the fuel cell system 22 after the reaction.

It is to be noted that the fuel cell 23 described here is merely one example, and needless to say, the present invention is applicable to various devices for sending and receiving the liquid, for example, an ink cartridge and a container for administering a drug solution. In this case, it is considered that the present invention is especially effective means as the joint device 21 in the device for sending and receiving the liquid, which is small-sized and has a small liquid sending flow rate.

Moreover, the shapes of the liquid reservoir 1 and the liquid accepter 4 are not limited to the above-mentioned examples of the embodiment, and the present invention is applicable to various shapes. Furthermore, the shapes of the snap hooks (the clasps) 3, 11 are not limited to cylindrical shapes (or circular sectional shapes). When the hooks are formed into a rectangular shape or the like, the shapes of the clasps 3, 11 themselves can be provided with a function of the mechanical key mechanism, that is, a function of preventing the liquid reservoir 1 having the different standard, size or the like from being joined. Therefore, the convex portions 17a, 18a and the concave portions 17b, 18b described in the present embodiment do not have to be formed.

### INDUSTRIAL APPLICABILITY

A joint device 21 for sending and receiving a liquid according to the present invention is applicable to a general joint mechanism for introducing the liquid from a liquid reservoir (a liquid supply container) 1 to a liquid accepter (a liquid receiver) 4 in a device such as the above-mentioned fuel cell system 22 or an ink jet printer in which the liquid reservoir 1 as liquid supply means is separated from the liquid accepter 4.

1-9. (canceled)

10. A joint device for sending and receiving a liquid, which connects a liquid reservoir to store the liquid to a liquid accepter to accept the liquid from the liquid reservoir,
wherein disengageable clasps which align a liquid sending side joint of the liquid reservoir with a liquid receiving side joint of the liquid accepter and which maintain a state where the liquid reservoir is connected to the liquid accepter are disposed at the liquid sending side joint of the liquid reservoir and the liquid receiving side joint of the liquid accepter.

11. A joint device for sending and receiving a liquid, which connects a liquid reservoir to store the liquid to a liquid accepter to accept the liquid from the liquid reservoir,
wherein a safety mechanism which prevents liquid leak from a supply valve due to incorrect contact at a time other than a joining time is disposed at a liquid sending side joint of the liquid reservoir.

12. A joint device for sending and receiving a liquid, which connects a liquid reservoir to store the liquid to a liquid accepter to accept the liquid from the liquid reservoir,
wherein mechanical key mechanisms which prevent a liquid reservoir having a different standard, size and the like from being joined are disposed at joints of the liquid reservoir and the liquid accepter, respectively.

13. The joint device for sending and receiving the liquid according to claim 11,
wherein the safety mechanism which prevents the liquid leak is a guard for the prevention of the liquid leak disposed at the joint of the liquid reservoir, and is formed so as to satisfy the following relation:
(d/S)≧4×10³,
in which S is a hole area of a through hole to pass the liquid, disposed at a front surface of the guard, and d is a length from the front surface of the guard to the supply valve.

14. The joint device for sending and receiving the liquid according to claim 10, which comprises the safety mechanism which prevents liquid leak from a supply valve due to incorrect contact at a time other than a joining time is disposed at a liquid sending side joint of the liquid reservoir.

15. The joint device for sending and receiving the liquid according to claim 14,
wherein the safety mechanism which prevents the liquid leak is a guard for the prevention of the liquid leak disposed at the joint of the liquid reservoir, and is formed so as to satisfy the following relation:
(d/S)≧4×10³,
in which S is a hole area of a through hole to pass the liquid, disposed at a front surface of the guard, and d is a length from the front surface of the guard to the supply valve.

16. The joint device for sending and receiving the liquid according to claim 10,
wherein mechanical key mechanisms which prevent a liquid reservoir having a different standard, size and the like from being joined are disposed at a liquid sending side joint of the liquid reservoir and a liquid receiving joint of the liquid accepter, respectively.

17. The joint device for sending and receiving the liquid according to claim 14,
wherein mechanical key mechanisms which prevent a liquid reservoir having a different standard, size and the like from being joined are disposed at a liquid sending side joint of the liquid reservoir and a liquid receiving joint of the liquid accepter, respectively.

18. The joint device for sending and receiving the liquid according to claim 16,
wherein the mechanical key mechanisms are constituted of concave portions disposed at a male side member and a female side member constituting the clasps and convex portions formed into such a shape as to be fitted into the concave portions.

19. A fuel cell system comprising: the joint device for sending and receiving the liquid according to any one of claims 10 to 18,
wherein the liquid reservoir is applied to a fuel cell using a liquid fuel.

20. The fuel cell system according to claim 19, wherein a fuel containing at leas methanol is used as the liquid fuel.
